(19) United States
(12) Patent Application Publication
(10) Pub. No.: US 2006/0030678 A1
(43) Pub. Date: Feb. 9, 2006

(54) Polyester-containing multilayer coextruded articles

(76) Inventors: Michael Joseph Brown, Wilmington, DE (US); Stephen R. Tanny, Newark, DE (US); Shailaja R. Vaidya, Landenberg, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/195,441

(22) Filed: Aug. 2, 2005

Related U.S. Application Data
(60) Provisional application No. 60/598,710, filed on Aug. 4, 2004.

(51) Int. Cl. C08F 20/00

(52) U.S. Cl. 525/437

(57) ABSTRACT

Disclosed is a profile-extruded multilayer structure comprising a polyester composition comprising from about 0.005 to about 7 mole % of a sulfonic acid comonomer or a salt thereof such as structures comprising at least one polyamide layer and at least one layer of a sulfonic acid-derived copolymer; structures comprising at least one polyester layer and at least one layer of a sulfonic acid-derived copolymer; structures comprising at least one polyamide layer, at least one layer of a sulfonic acid-derived copolymer and at least one polyester or polycarbonate layer. Also disclosed are shaped articles comprising these multilayer structures, commonly referred to as profiles. Such profiles are useful, for example, as tubing.

This application claims priority to U.S. Provisional Application No. 60/598,710, filed Aug. 4, 2004 the entire disclosure of which is incorporated herein by reference.

This invention relates to a multilayer structure comprising a polyester composition comprising polymer or repeat units derived from a sulfonic acid comonomer or a derivative thereof and to an article therewith such as extrusion of these polyester-containing multilayer structures to form shaped articles commonly referred to as profiles, which are useful, for example, as tubing.

### BACKGROUND OF THE INVENTION

Thermoplastic materials are commonly used to manufacture various shaped articles which may be utilized in applications such as automotive parts, food containers, signs, packaging materials and the like. One such article is a profile. Profiles are defined by having a particular shape and by their process of manufacture known as profile extrusion. Profiles are not film or sheeting, and thus the process for making profiles does not include the use of calendering or chill rolls. Profiles are also not prepared by injection molding processes. Profiles are fabricated by melt extrusion processes that begin by extruding a thermoplastic melt through an orifice of a die forming an extrudate capable of maintaining a desired shape. The extrudate is typically drawn into its final dimensions while maintaining the desired shape and then quenched in air or a water bath to set the shape, thereby producing a profile. In the formation of simple profiles, the extrudate preferably maintains shape without any structural assistance. With extremely complex shapes, support means are often used to assist in shape retention. In either case, the type of thermoplastic resins used and their melt strength during formation is critical.

A common shape of a profile is tubing. Tubing assemblies for the transport of liquids and vapors are well known in the art. In automotive applications such as fuel lines, air brake lines, hydraulic fluid lines and the like, tubing assemblies are exposed to a variety of deleterious and harmful conditions. The tubing is in nearly constant contact with automotive fluids and additives. Also, there are external environmental factors such as stone impact and corrosive media (such as salt) to consider. Furthermore, temperatures often rise to extremely high levels, and in cold climates, there is exposure to extremely low temperatures as well.

Tubing is also used for fluid transfer in medical applications or in transferring fluids such as beverages. These applications require good moisture barrier properties, chemical resistance, toughness and flexibility.

Polymers typically used for making profiles include poly(vinyl chloride) (PVC), acrylic polymers, and polycarbonate. Each of these polymers suffers from one or more disadvantages. For example, PVC is undesirable from an environmental standpoint. Acrylic objects are brittle and shatter when dropped or struck against another object. Polycarbonate is too expensive for many applications. Rubber, natural or synthetic, tend to age in the presence of air and have well recognized temperature limitations. Such polymer profiles are also known to include reinforcement and/or jacketing as part of their construction.

Polyesters have also been used for making profiles. Polyesters such as polyethylene terephthalate (PET), polybutylene terephthalate (PBT) and polyester elastomers and similar materials offer a wide range of desirable properties. The use of such polyester materials as the materials of choice in the formation of numerous extruded articles is well known in the art. For example, polyesters such as PET generally evidence high strength, good clarity, and low gas permeation characteristics. Polyester elastomers include polyetherester block copolymers consisting of a hard (crystalline) segment of polybutylene terephthalate and soft (amorphous) segments based on long-chain polyether glycols. These materials are available from E. I. du Pont de Nemours and Company (DuPont, Wilmington, Del., USA) under the Hytrel® tradename. Polyester elastomers offer good flexibility, strength, impact resistance and creep resistance at high and low temperatures without the use of plasticizers. Their flexibility is typically between that of rubber and that of engineering plastics. They exhibit high flex crack and abrasion resistance over a broad service temperature range and excellent resistance to a broad variety of oils fuels and aliphatic or aromatic solvents. They are useful in a wide variety of applications such as in automotive parts, mechanical devices, housings, tubing and sporting goods.

In many cases, it is desirable to combine properties of more than one material in an article. Such combined properties can be obtained by blending two or more materials into a single composition. Alternatively, multilayer structures provide a preferred means of combining properties. The materials of each layer have specific, and preferably complementary, properties. Inner tubing layers, for example, are typically designed to be resistant to permeation by liquids and gases, while outer layers possess mechanical strength and shock resistance. See, e.g., U.S. Pat. Nos. 3,561,493; 4,643,927; 4,887,647; 5,038,833; and 5,076,329.

It is often desirable to make multilayer structures with polymers having significantly different compositions. The different compositions may exhibit little or no adhesion to each other resulting in poor interlayer adhesion of the multilayer structures. For example, polyesters have little or no adhesion to polyamides limiting their application in multilayer structures. Similarly, polycarbonate and polyamides do not adhere well.

Multilayer structures comprising PET and various performance layers providing improved barrier properties are known. See, e.g., JP Patent 04051423 and Japanese Patent 2663578. See also PCT Publication WO99/58328.

There is a need for an improved tubing that provides the necessary durability and resistance to permeation through the utilization of a dual or multi-layer structure characterized by increased adhesive bond strength between the layers. There is also a need for multilayer structures with interlayer adhesion that can be used in profile extrusion to form articles.

### SUMMARY OF THE INVENTION

The invention includes a polyester composition comprising repeat units derived from about 0.001 to about 20, about 0.001 to about 7, about 0.005 to about 7, or about 0.025 to about 2.5, mole % of a sulfonic acid comonomer, in which the sulfonic acid can be a sulfobenzenedicarboxylic acid, a derivative thereof, or combinations thereof; the derivative can be a salt, an ester of the acid, an ester of the salt, or combinations of two or more thereof; the polyester composition can also be a blend of bulk polyester and a copolymer of polyester and the sulfonic acid comonomer where the blend ratio of bulk polymer to sulfonic acid-derived copolymer can be about 0.1:99.9 to about 99.9:0.1, or about 75:25 to about 99.9:0.1; and the sulfonic acid-derived polyester composition can be a random copolyester, block copolyester, or combinations thereof. The composition can include polyethylene terephthalate 5-sodium sulfoisophthalate terpolymer, a blend of polyethylene terephthalate 5-sodium sulfoisophthalate terpolymer and polyetherester elastomer block copolymer, a blend of polyethylene terephthalate 5-sodium sulfoisophthalate terpolymer and polyethylene terephthalate, a blend of polyethylene terephthalate 5-sodium sulfoisophthalate terpolymer and ethylene/acrylic acid copolymer and ethylene/methyl acrylate copolymer, a blend of polyethylene terephthalate 5-sodium sulfoisophthalate terpolymer and ethylene/acrylic acid copolymer and ethylene/n-butyl acrylate copolymer, a blend of polyethylene terephthalate 5-sodium sulfoisophthalate terpolymer and ethylene/n-butyl acrylate glycidyl methacrylate terpolymer, or combinations of two or more thereof.

The invention also includes a coextruded or profile-extruded multilayer structure comprising a polyester composition disclosed above.

This invention also includes a profile-extruded multilayer structure comprising (a) a first layer comprising a sulfonic acid-derived polyester composition, (b) a second layer comprising polyamide, and (c) optionally a third layer including a second polyester, polycarbonate, or both where “first”, “second”, or “third” is merely for the convenience of reference, does not restrict the order of the layers, and can itself include one or more layers.

This invention also includes a profile comprising the multilayer structure including tubing.

Also included is a process that can be used to make a block copolymer comprising contacting a first polyester with a second polyester under a solid state polymerization condition wherein the first polyester comprises repeat units derived from a sulfonic acid, the second polyester is a thermoplastic polyetherester elastomer.

### DETAILED DESCRIPTION OF THE INVENTION

“Monomer” is a relatively simple compound, usually containing carbon and of low molecular weight, which can react to form a polymer by combining with like molecules or with other similar molecules or compounds. “Comonomer” is a monomer that is copolymerized with at least one different monomer in a copolymerization reaction, the result of which is a copolymer. “Polymer” is the product of a polymerization reaction, and is inclusive of homopolymers, copolymers, terpolymers, tetrapolymers, etc. The layers of a structure can consist essentially of a single polymer, or can have additional polymers together therewith, i.e., blended therewith.

“Homopolymer” is a polymer resulting from the polymerization of a single monomer, i.e., a polymer consisting essentially of a single type of repeating unit. “Copolymer” is a polymer formed by the polymerization reaction of at least two different monomers and includes a random copolymer, block copolymer, graft copolymer, or combinations of two or more thereof.

As used herein, terms identifying polymers, such as “polyamide”, “polyester”, “polyurethane”, etc., are inclusive of not only polymers comprising repeating units derived from monomers known to polymerize to form a polymer of the named type, but are also inclusive of comonomers, derivatives, etc., that can copolymerize with monomers known to polymerize to produce the named polymer. For example, the term “polyamide” encompasses both polymers comprising repeating units derived from monomers, such as caprolactam, which polymerize to form a polyamide, as well as copolymers derived from the copolymerization of caprolactam with a comonomer which when polymerized alone does not result in the formation of a polyamide. Furthermore, terms identifying polymers are also inclusive of blends of such polymers with other polymers of a different type.

Polyamide can include polyamide 6, polyamide 9, polyamide 10, polyamide 11, polyamide 12, polyamide 6,6, polyamide 6,6,6 polyamide 6,10, polyamide 6,12, polyamide 6I, polyamide 6T, polyamide 6I 6T, polyamide 6,9, as well as polyamides prepared from terephthalic acid and/or isophthalic acid and trimethylhexamethylenediamine, from adipic acid, azelaic acid, 2,2-bis-(p-aminocyclohexyl)propane, from terephthalic acid and 4,4′-diaminocyclohexylmethane, or combinations of two or more thereof.

Polyamides may be made by any method known to one skilled in the art, including the polymerization of a monoamino monocarboxylic acid or a lactam thereof having at least two carbon atoms between the amino group and carboxylic acid group, of substantially equimolar proportions of a diamine which contains at least two carbon atoms between the amino groups and a dicarboxylic acid, or of a monoaminocarboxylic acid or a lactam thereof as define above, together with substantially equimolar portions of a diamine and a dicarboxylic acid. This dicarboxylic acid may be used in the form of a functional derivative thereof, for example, a salt, an ester or acid chloride. See, e.g., U.S. Pat. Nos. 4,755,566; 4,732,938; 4,659,760; and 4,315,086, each also incorporated herein by reference. The polyamide used may also be one or more of those referred to as “toughened nylons,” which are often prepared by blending one or more polyamides with one or more polymeric or copolymeric elastomeric toughening agents. Examples of these types of materials are given in See, e.g., U.S. Pat. Nos. 4,174,358; 4,474,927; 4,346,194; 4,251,644; 3,884,882; and 4,147,740, each also incorporated herein by reference. Because such methods are well known, the description of which is omitted herein for the interest of brevity.

The polyamide in the polyamide layer preferably comprises at least one polyamide selected from the group consisting of polyamide 6, polyamide 9, polyamide 10, polyamide 11, polyamide 12, polyamide 6,6, polyamide 6,10, polyamide 6,12, polyamide 6I, polyamide 6T, polyamide 6I 6T, polyamide MXD6 (i.e., polymetaxylene adipate homo- and/or co-polyamides), polyamide 6,9, a copolymer thereof, and combinations of two or more thereof including polyamide nanocomposites such as those available commercially as Aegis™ from Honeywell or Imper™ from Mitsubishi Gas Chemicals/Nanocor.

Polyesters comprise repeat units derived from at least one diol comonomer and at least one dicarboxylic acid comonomer and can include, e.g., PET, polypropylene terephthalate (PPT), PBT, and blends with additional components such as modifiers and tougheners. “Polyester” also includes polyester elastomers such as the previously mentioned polyetherester block copolymers consisting of a hard (crystalline) segment of polybutylene terephthalate and soft (amorphous) segments based on long-chain polyether glycols (e.g. Hytrel®). For example, a polyester composition comprising at least about 65 weight % PET or Hytrel® can be used. PET can be a homopolymer (polymer substantially derived from the polymerization of ethylene glycol with terephthalic acid, or alternatively, derived from the ester forming equivalents thereof (e.g., any reactants that can be polymerized to ultimately provide a polymer of polyethylene terephthalate) or copolymer (any polymer comprising (or derived from) at least about 50 mole percent ethylene terephthalate, and the remainder of the polymer being derived from monomers other than terephthalic acid and ethylene glycol (or their ester-forming equivalents)). Comonomers include, for example, di-acids such as succinic acid, adipic acid, azelaic acid, sebacic acid, glutaric acid 1,10-decanedicarboxylic acid, phthalic acid, isophthalic acid, dodecanedioic acid, and the like; and ester-forming equivalents thereof. Ester-forming equivalents include diester such as dimethylphthalate. Other comonomers include, for example, diols such as propylene glycol, methoxypolyalkylene glycol, neopentyl glycol, trimethylene glycol, tetramethylene glycol, hexamethylene glycol, diethylene glycol, polyethylene glycol, cyclohexane dimethanol and the like. Trimellitic anhydride, trimellitic acid, pyromellitic dianhydride (pmda), pentaerythritol or other acids or diols that have more than two reactive sites can be incorporated as branching agents to increase the melt viscosity and improve the rheology for coextrusion in multilayer profiles. Polyesters may also be nucleated to improve crystallinity, heat resistance and potentially optical clarity. Suitable nucleation agents include salts of organic acids, such as sodium stearate. Linear low density polyethylene or polypropylene may be suitable nucleants depending on the end use application. Because polyesters are so well known to one skilled in the art, the description of which is omitted for the interest of brevity.

Polyesters can also be blended with other components such as tougheners. Tougheners include, for example but not limitation, ethylene copolymers including ethylene/alkyl (meth)acrylate copolymers (e.g. ethylene/methyl acrylate), ethylene/alkyl acrylate/glycidyl (meth)acrylate copolymers (e.g. ethylene/n-butyl acrylate/glycidyl methacrylate; i.e., EnBAGMA) and ethylene/(meth)acrylic acid copolymers and corresponding copolymers partially neutralized with metal ions (i.e., ionomers). Toughened polyesters can comprise from about 3 to about 25, about 5 to about 20, or about 8 to about 18, weight % of one or more tougheners.

In an embodiment, a PET homopolymer or copolymer having a melt temperature (Tm) in a range from about 150° C. to about 300° C. or about 195° C. to about 258° C. or about 230° C. to 258° C. and an inherent viscosity (IV) from 0.58 to 1.1 is blended with a copolymer of polyester having from, e.g., about 0.001 to about 20, or about 0.005 to about 7, mole % of a sulfonic acid comonomer.

A PET homopolymer or copolymer with Tₘ in a range from about 245° C. to 258° C. and an inherent viscosity (IV) from 0.72 to 0.9 can be used. PETs as described above are sometimes referred to as a “bottle resin” or “CPET resin” and include those such as “9921” from Voridian or “Laser+” from DAK Americas.

The copolymer of polyester and a sulfonic acid comonomer used herein includes any polymer comprising (or derived from) terephthalic acid or a terephthalate diester such as dimethylterephthalate and ethylene glycol in amounts such that the copolymer comprises at least about 50 mole % ethylene terephthalate, and the remainder of the polymer being derived from comonomers comprising a sulfo (i.e. sulfonic acid) moiety, such as sulfoterephthalic acid or 5-sulfoisophthalic acid, their salts and/or ester forming equivalents thereof.

The copolymer can be in the neutralized form (i.e. in the form of an alkali, alkali metal or metal salt). When in the salt form, these copolymers are also known as polyester ionomers, sulfonate polyesters or metal sulfonate polyesters. The term “sulfonic acid-containing polyester copolymer” is used herein to denote such copolymers, including the salt form. Suitable polyester ionomers can also be found in U.S. Pat. No. 6,437,054. A preferred comonomer is 5-sulfoisophthalic acid; an example of an ester forming equivalent thereof is the sodium salt of 5-sulfo-1,3-dimethyl ester 1,3-benzenedicarboxylic acid (also known as 5-sodium sulfodimethylisophthalate). Preferred is a polyester copolymer derived from copolymerization of ethylene glycol with terephthalic acid to 5-sulfoisophthalic acid (or equivalents, including esters and/or salts).

The copolymers of polyester and a sulfonic acid include random copolymers or block copolymers. Random copolymers have a random distribution of the sulfonic moiety through the copolymer. When mixing the terephthalic acid comonomer and the ethylene glycol comonomer and allowing them to partially condense prior to adding the sulfonic comonomer can result in block copolymer having “blocks” or regions of essentially homogeneous polyethylene terephthalate and regions wherein the sulfonic moieties are randomly distributed among the terephthalic and ethylene glycol moieties. Trimellitic anhydride, trimellitic acid, pmda, pentaerythritol or other acids or diols that have more than two reactive sites can be incorporated as branching agents to increase the melt viscosity and improve the rheology for coextrusion in multilayer profiles. Block copolyesters can also be produced by melt blending and homopolymer or copolymer polyester or polyetherester block copolymers with a sulfonic acid copolyester and subsequently solid state polymerizing of the blend for a limited period of time.

A PBT homopolymer can be used as bulk polyester into which the sulfonic acid-containing polyester copolymer is blended. The sulfonic acid-containing polyester copolymer can be derived from copolymerization of tetramethylene glycol (butylene glycol) with terephthalic acid to 5-sulfoisophthalic acid (or equivalents, including esters and/or salts). These copolymers can be described as above by substitution of tetramethylene glycol for ethylene glycol. These copolymers can be random copolymers (in which all the comonomers of the copolymer are mixed together simultaneously and condensed) or block copolymers (prepared by mixing the terephthalic acid comonomer and the tetramethylene glycol comonomer and allowing them to partially condense prior to adding the sulfonic comonomer).

Polyester also includes copolyetheresters (also known as a poly-ether-ester block copolymers, block poly-ether-esters, polyester elastomers, or thermoplastic poly-ether-esters). Copolyetheresters are well known materials having high strength and flexibility characteristics.

A copolyetherester is a block copolymer containing both polyether and ester blocks. Copolyetheresters are available as Hytrel® (e.g., Hytrel® 5556) from DuPont, Arnitel™ from DSM, and Pelprene™ from Toyobo.

Copolyetheresters are discussed in detail in U.S. Pat. Nos. 3,651,014; 3,766,146; and 3,763,109 including copolyetherester having polyether segment obtained by polymerization of tetrahydrofuran (i.e. poly(tetramethylene ether)) and polyester segment obtained by polymerization of tetramethylene glycol and phthalic acid (i.e. 1,4-butylene terephthalate). The more polyether units incorporated into the copolyetherester, the softer the polymer.

Copolyetheresters also include polyester-polyether block copolymers comprising repeat units derived from 30 to 90 wt % of 1,4-butylene terephthalate and from 10 to 70 wt % of poly(tetramethylene ether) terephthalate. Copolyetheresters have excellent low temperature properties (freezing) and are impervious to chemicals, oils and tissue.

When a copolyetherester is used as the bulk polyester, the sulfonic acid-containing polyester copolymer is preferably a 5-sulfoisophthalic acid (SIPA) derived copolyetherester, as either a random or block copolymer. Random copolymers include those in which SIPA and the polyether and polyester precursors are mixed together simultaneously and condensed. Block copolymers can be prepared by mixing the polyether and polyester precursors and allowing them to partially condense prior to adding the sulfonic copolymer. Block copolymers also can be PET (or PBT or Copolyetheresters) SIPA copolymers compounded with a thermoplastic elastomer and subsequently solid-state polymerized to create copolymers, block copolymers or copolymer blends. Random copolymers, block copolymers or blends of copolyetheresters and SIPA-containing PET (sPET) can be used either as a bulk layer or as a tie layer.

As used herein, “inner layer,” “interior layer” and “internal layer” refer to any layer of a multilayer structure having both of its principal surfaces directly adhered to another layer of the structure. “Outer layer” and “exterior layer” refer to any layer of a multilayer structure having less than two of its principal surfaces directly adhered to another layer of the structure. All multilayer structures have two, and only two, outer or exterior layers, each of which has a principal surface adhered to only one other layer of the multilayer structure. “Inside layer” refers to an outer or exterior layer of a multilayer structure for, for example, fluid transfer that is closest to the fluid relative to the other layers of the multilayer structure. “Inside layer” also refers to the innermost layer of a plurality of concentrically arranged layers simultaneously coextruded through a profile die. An inside layer is used with reference to the layer that forms the surface of the inside of the profile or tubing. “Outside layer” refers to the outer layer of a multilayer structure for fluid transfer that is farthest from the fluid relative to the other layers of the multilayer structure. “Outside layer” also is used with reference to the outermost layer of a plurality of concentrically arranged layers simultaneously coextruded through a profile die. An outside layer is used with reference to the layer that forms the surface of the outside of the profile or tubing.

“Directly adhered”, as applied to layers, is adhesion of the subject layer to the object layer, without an intervening tie layer, adhesive layer, or other layer. In contrast, as used herein, the word “between”, as applied to a layer expressed as being between two other specified layers, includes both direct adherence of the subject layer between to the two other layers it is between, as well as including a lack of direct adherence to either or both of the two other layers the subject layer is between, i.e., one or more additional layers can be imposed between the subject layer and one or more of the layers the subject layer is between.

The term “core” and “core layer”, as applied to multilayer structures, respectively refers to any interior layer that has a primary function other than serving as an adhesive or compatibilizer for adhering two layers to one another. The core layer or layers can provide the multilayer structure with a desired level of strength (i.e., modulus) and/or optics, and/or added abuse resistance, and/or specific impermeability.

“Tie layer” or “adhesive layer” refer to any interior layer having the primary purpose of adhering two layers to one another. Tie layers can comprise any polymer having a polar group thereon, or any other polymer that provides sufficient interlayer adhesion to adjacent layers comprising otherwise non-adhering polymers. In some cases an additive can be blended into a layer, an inner layer, an outer layer or both, in order to promote adhesion to another layer.

Tie layer compositions used in this invention can include those sulfonic acid-derived polyester compositions disclosed above. They may also include blends of sulfonic acid-derived copolymers with PET (e.g., PET having a high IV and/or a branched PET). The compositions may also be toughened and/or nucleated as described above (e.g., inclusion of 18 weight % EnBAGMA and/or a sodium salt of an organic acid to provide 1000 ppm Na⁺). Although the compositions are generally described herein as containing sodium counterions, other counterions such as lithium, calcium and zinc may be used. Low-melting SIPA-PET copolymers may be particularly useful in some multilayer structures.

“Bulk layer” refers to any layer of a structure that is present for the purpose of increasing the abuse-resistance, toughness, modulus, etc., of a multilayer structure. Bulk layers can comprise polymers that are generally inexpensive relative to other polymers in the structure that provide some specific purpose unrelated to abuse-resistance, modulus, etc. The bulk layer is typically the majority of the structure.

“Barrier” and “barrier layer”, as applied to multilayer structures, refer to the ability of a structure or layer to serve as a barrier to one or more gases or chemical. In the packaging art, oxygen (i.e., gaseous O₂) barrier layers include, e.g., hydrolyzed or saponified ethylene/vinyl acetate copolymer (“HEVA”, also referred to as ethylene/vinyl alcohol copolymer (EVOH)), polyalcohol ethers, polyvinylidene chloride, polyamides, polyacrylonitrile, polyesters, wholly aromatic polyesters, resorcinol diacetic acid-based copolyesters, polyalcohol amines, isophthalate-containing polyesters, polyethylene naphthalate (PEN) and PEN copolymers and mixtures thereof, etc., as known to those of skill in the art. These materials may be used neat or further modified to improve their physical properties, such as with the addition of nanoparticles (to improve barrier), such as those available from Nanocor, Southern Clay Products, Rheox and others. Barrier structures can also be designed to resist hydrocarbons, moisture, or any material of interest. Polyamides have particularly good barrier to hydrocarbons.

“Skin layer” refers to an outside layer of a profiled multilayer structure, this skin layer being subject to abuse.

“Fluid-contact layer” refers to a layer of a multilayer structure such as tubing that is in direct contact with the fluid being held or transferred in the tubing. In a multilayer structure, a fluid-contact layer is always an outer layer. The fluid-contact layer is an inside layer with respect to the tubing, i.e., the innermost layer of the tubing, this inside layer being in direct contact with the fluid.

The sulfonic acid-derived polyester compositions provide good bonds between the polyamides and polyesters or polycarbonates, allowing the preparation of multilayer structures. Those bonds remain strong in the presence of solvents, unlike conventional olefin tie layers.

A multilayer structure of this invention may comprise at least one layer comprising a sulfonic acid-derived polyester composition as defined above; and at least one polyamide layer. A multilayer structure may comprise at least one inner layer comprising a sulfonic acid-derived polyester composition as defined above, at least one polyamide layer and at least one polyester layer or may comprise at least one inner layer comprising a sulfonic acid-derived polyester composition as defined above, at least one polyamide layer, and at least one polycarbonate layer. Optionally an additional barrier layer or abuse layer could be included. Typical structures can include up to 13 layers or up to 5 to 7 layers.

One embodiment of a two-layer structure involves polyester or polyetherester random SIPA copolymer or blend of such SIPA copolymer with a bulk polymer coextruded with a polyamide layer. Such a structure can have one layer of a blend of a copolyetherester with a sulfonic acid copolymer of polyethylene terephthalate and a second layer of a polyamide.

An embodiment of a multilayer structure is a three-material, three-layer structure that can be profile extruded into, for example tubing. In this embodiment, a first exterior layer comprises a polyester composition, the inner layer comprises a sulfonic acid-derived polyester composition as described above and the second exterior layer comprises a polyamide composition. For articles such as tubing, one exterior layer provides the outside surface of the article and the other exterior layer provides the inside surface (the fluid-contact surface) of the article.

A three-layer structure of note is a “TPE/tie/polyamide” structure where “tie” indicates a sulfonic acid-derived polyester composition as described herein and “TPE” indicates a thermoplastic polyester elastomer as described herein. In this example, the TPE serves as the outside layer of a tubing profile and the polyamide serves as the inside layer. Another three-layer structure of note is a “polycarbonate/tie/polyamide” structure where “tie[ indicates a sulfonic acid-derived polyester composition as described herein. In this example, the polycarbonate serves as the outside layer of a tubing profile and the polyamide serves as the inside layer. The polyamide may be toughened as described above. A multilayer structure comprising “polycarbonate/tie/toughened polyamide” may be particularly useful for high temperature applications. A “polycarbonate/tie/polyamide” structure can include a regrind layer and remain optically clear. A [regrind+polycarbonate+sulfonic acid copolymer]/polyamide may be an optically clear structure, particularly if the polyamide is an aromatic nylon such as 6I,6T which has a refractive index similar to the polycarbonate. A regrind layer is well known to one skilled in the art.

The invention is also useful, for example, in four-material, four-layer structures as well. In this embodiment where four materials form a four-layer object, applications can be for tubing comprising two interior layers; one layer would be a sulfonic acid-derived polyester composition as described above as a tie layer and the other interior layer would be selected for its barrier properties or for some other property such as a structural layer or a recycled layer. The exterior layers comprise a layer comprising a polyester composition and a layer comprising a polyamide as described above.

Interior core layer can be a barrier layer, where a moisture-sensitive barrier layer may be required within the tubing. It may shift the barrier layer towards the outside walls of the tubing, away from the liquid content and thus at a lower relative humidity environment that can enhance the performance of the barrier layer and even require less volume of barrier material in order to provide the same barrier effect to the contents. Another illustration is for use of adhesive layers, the performance of which may be affected by being in a higher relative humidity and/or being closer to the core as opposed to being close to the outside wall. A thicker outside layer permit less moisture permeation than if the outside layer were thinner, slowing down moisture transfer from the outside to the adhesive layer. While the invention is useful with all kinds of polymers as components of the interior core layer, at least one polymeric material selected from the group consisting of polyamides, EVOH, polyvinylidene chloride, and polyalkylene carbonate is useful for barrier properties.

“EVOH” refers to an ethylene/vinyl alcohol copolymer, includes saponified or hydrolyzed ethylene/vinyl acetate copolymers, refers to a vinyl alcohol copolymer having an ethylene comonomer, and is prepared by, e.g., hydrolysis of vinyl acetate copolymers. The degree of hydrolysis is preferably from about 50 to 100 mole %, or about 85 to 100 mole %.

Examples of five-layer structures include: Nylon 11/tie/TPE/tie/Nylon 11 and TPE/tie/nylon 11/tie/TPE where “tie” indicates a sulfonic acid-derived polyester composition as described herein and “TPE” indicates a thermoplastic polyester elastomer as described herein.

Appropriate amounts of various additives as generally practiced in the art can be present in the compositions, and structure layers thereof, including tie layers and the like. The additives include antioxidants, radiation stabilizers, thermal stabilizers, and ultraviolet (UV) light stabilizers, colorants, pigments or dyes, fillers, delustrants such as TiO₂, anti-slip agents, slip agents such as talc, plasticizers, anti-block agents, antistatic agents, other processing aids, elastomers, or combinations of two or more thereof.

The profile-extruded multilayer structures are useful in making articles known as profiles. By coextruding, for example, a thermoplastic elastomer such as Hytrel® with a polyamide such as nylon 11, one can obtain the property of both materials and the costs for the profile structure can be reduced.

Examples of uses of tubing include airbrake tubes, hydraulic hoses and other fluid-transfer tubes. Although described herein primarily in the form of tubing, the multilayer structures can be used in other applications such as, for example, in over-molded parts. Thermoplastic elastomers cannot currently be used as over-moldings on parts such as casings of drills and other hand tools because of their insufficient adhesion to nylon. Use of the adhesive compositions allows thermoplastic elastomers to be used as over-moldings. A profile-extruded multilayer structure comprising at least one layer of sulfonic acid-derived polyester composition and at least one polyester layer can be useful for over-molding onto polyamide surfaces. Example of over-molding includes a polyester elastomer such as a polyetherester block copolymer.

The invention also includes a process that can be used to make a block copolymer. The process comprises contacting a first polyester with a second polyester to produce a blend and polymerize under a solid state polymerization condition to produce a block copolymer. The first polyester comprises repeat units derived from a sulfonic acid, which can be the same as that disclosed above and the second polyester can be a thermoplastic polyetherester elastomer or polyether elastomer such as Hytrel® disclosed above. The first polyester and second polyester can each be present in the blend in the range of from about 25-75 wt %. The solid state polymerization is well known to one skilled in the art, the description of which is omitted for the interest of brevity. The condition can include a temperature that is about 10° C. to about 60° C. below the melting point of the lower melting polyester (e.g., Hytrel® has a melting point of about 215° C. mp) under a reduced pressure (vacuum) or atmospheric pressure.

The following Examples are merely illustrative, and are not to be construed as limiting the scope of the invention. Unless stated otherwise, all percentages, parts, etc., are by weight.

### EXAMPLES

Polyester compositions comprising a sulfonic acid comonomer or a salt thereof were prepared according to standard methods.

### Example 1

This example was a copolyester of terephthalic acid (or dimethyl terephthalate), ethylene glycol and 5-sodium sulfodimethylisophthalate (2.0 mole % based on the acid component). The IV of the copolymer is 0.56.

### Example 2

This example is a copolyester of terephthalic acid (or dimethyl terephthalate), ethylene glycol to 5-sodium sulfodimethylisophthalate (2.0 mole % based on the acid component) with 0.3 weight % TiO₂. The IV of the copolymer is 0.5.

### Examples 3 Through 9

Blend compositions were prepared by mixing the Example 1 or Example 2 composition with the materials listed below according to standard methods using a 28-mm diameter twin-screw compounder. The compositions are listed in Table 1 (the numbers in parenthesis indicate the weight % of the component).

Materials Used

EA-1: An acid-modified ethylene acrylate copolymer, with melt index (MI) of 10, available from E. I. du Pont de Nemours and Company, Wilmington, Del., under the tradename Bynel® 2002.
EMA-1: An ethylene/methyl acrylate (24 weight %) copolymer with MI of 2.0 available from E. I. du Pont de Nemours and Company.
EBA-1: An ethylene/n-butyl acrylate (27 weight %) copolymer with MI of 4.0 available from E. I. du Pont de Nemours and Company.
PET-1: A polyethylene terephthalate available from E. I. du Pont de Nemours and Company under the tradename Selar® PTX175.
TEEE-1: A thermoplastic polyetherester elastomer block copolymer, having nominal hardness of 55 (measured according to ASTM D2240) and flexural modulus of 193 Mpa (measured according to ASTM D790 at room temperature), available from E. I. du Pont de Nemours and Company, Wilmington, Del., under the tradename Hytrel® G5544.

TEEE-2: A thermoplastic polyetherester elastomer block copolymer, having nominal hardness of 40 (measured according to ASTM D2240) and flexural modulus of 55 Mpa (measured according to ASTM D790 at room temperature), available from E. I. du Pont de Nemours and Company, Wilmington, Del., under the tradename Hytrel® 4069.

TABLE 1

| Example | Composition |
|---|---|
| 3 | Example 1 (85) + EA-1 (13) + EMA-1 (2) |
| 4 | Example 1 (85) + EA-1 (13) + EBA-1 (2) |
| 5 | Example 1 (85) + TEEE-1 (15) |
| 6 | Example 1 (85) + TEEE-2 (15) |
| 7 | Example 2 (40) + TEEE-2 (60) |
| 8 | Example 1 (50) + PET-1 (50) |
| 9 | Example 1 (75) + PET-1 (25) |

### Examples 10-13

To test interlayer adhesion, multilayer sheets were prepared by standard coextrusion methods using the materials listed below. Comparative Example C1 was prepared similarly. The multilayer structures are reported in Table 2 below.

Materials Used

TEEE-3: A thermoplastic polyetherester elastomer block copolymer, available from DuPont as Hytrel® 5556.
PA-1: A nylon 11 polyamide, available from Atofina, Philadelphia, Pa., under the tradename Rilsan® BMNO.
PA-2: A nylon 6,6 polyamide, available from DuPont under the as Zytel® 3071.
PA-3: A nylon 6,12 polyamide, available from DuPont as Zytel® 158.
PA-4: A nylon 11 polyamide, available from Atofina, Philadelphia, Pa., under the tradename Rilsan® BESNO.

### Tests Employed in Examples

Adhesion Strength: One-inch (2.54 cm) wide strips were cut in the machine direction from near the center of the coextrudate. The layers were separated at the nylon/tie layer interface unless otherwise noted and pulled to assess the interlayer adhesion. Three to five separate determinations were tested and reported in the Tables as a general qualitative conclusion. The mode of adhesion shown in Table 1 was characterized by one or more of the following possible descriptors.

I=Inseparable

M=peelable w/ adhesion

N=No Adhesion

TABLE 2

| Ex. | Multilayer Structure | Adhesion |
|---|---|---|
| 10 | TEEE-3 (8 mil)/Example 1 (3 mil)/PA-1 (3 mil) | I |
| 11 | TEEE-3 (8 mil)/Example 2 (3 mil)/PA-1 (3 mil) | I |
| 12 | TEEE-3 (8 mil)/Example 1 (3 mil)/PA-2 (3 mil) | I |
| 13 | TEEE-1 (8 mil)/Example 1 (3 mil)/PA-3 (3 mil) | I |
| C1 | TEEE-1 (8 mil)/PA-4 (3 mil) | N |

The results shown in Table 2 show that a polyamide did not adhere to a polyester thermoplastic elastomer (C1). Use of a tie layer as described herein (Examples 10-13) provided interlayer adhesion.

### Examples 14-24

Examples of three-layer coextruded tubing having an outer diameter of 0.375 inches (0.95 cm) and nominal wall thickness were prepared from the materials reported in Table 3 under the standard conditions listed below.

The outside layer was extruded through a 1.5-inch (3.8 cm) diameter Davis Standard extruder using a general-purpose extruder screw with length/diameter (L/D) ratio of 30:1 and a compression ratio of 3:1. The inner adhesive layer was extruded through a 1-inch (2.54 cm) diameter Entwistle extruder using a mixing head extruder screw with L/D ratio of 20:1 and a compression ratio of 3:1. The inside layer was extruded through a 1-inch (2.54 cm) diameter Davis Standard extruder using a mixing head extruder screw with L/D ratio of 30:1 and a compression ratio of 3:1. The layers were extruded through a Guill diebody having a 0.888 (2.26 cm) inch die diameter and a 0.673 inch (1.715 cm) tip diameter using a “3-layer” setup.

The vaccum box had a water seal plate diameter of 0.414 inches (1.05 cm) and a sizing die diameter of 0.328 inches (0.833 cm). The exit gaskets were #4 punch.

TABLE 3

| Example | Outside Layer | Adhesive Layer | Inside Layer |
|---|---|---|---|
| 14 | TEEE-3 | Example 1 | PA-1 |
| 15 | TEEE-3 | Example 8 | PA-1 |
| 16 | TEEE-3 | Example 8 | PA-1 |
| 17 | TEEE-3 | Example 8 | PA-1 |
| 18 | TEEE-3 | Example 4 | PA-1 |
| 19 | TEEE-3 | Example 5 | PA-1 |
| C2 | TEEE-3 | PA-1 | PA-1 |
| 20 | TEEE-3 | Example 9 | PA-4 |
| 21 | TEEE-3 | Example 8 | PA-4 |
| 22 | TEEE-3 | Example 3 | PA-4 |
| 23 | TEEE-3 | Example 4 | PA-4 |
| 24 | TEEE-3 | Example 6 | PA-4 |

### Tests Employed in Examples

The tubing examples were held at 135° C. for 72 hours to assess their thermal stability. The tubing structures retained adhesion, but the tie layers showed evidence of brittleness.

The tubing was also treated at 100° C. at 90% relative humidity. Adhesion was retained during this treatment.

The tubing was also treated for two hours by immersion in boiling water. There was an initial loss of adhesion, but adhesion recovered over time. This recovery was unexpected. There was an initial loss of adhesion, but adhesion recovered over time. This recovery was unexpected.

Although the present invention has been described with reference to the preferred embodiments, it is to be understood that modifications and variations of the invention exist without departing from the principles and scope of the invention, as those skilled in the art will readily understand. Accordingly, such modifications are in accordance with the claims set forth below.

1. A profile-extruded multilayer structure comprising, or produced from, a composition wherein the composition is a polyester composition comprising from about 0.001 to about 7 mole % of a sulfonic acid comonomer and optionally an ethylene copolymer wherein the sulfonic acid includes sulfobenzenedicarboxylic acid, a salt of the acid, an ester of the acid, an ester of the salt, or combinations of two or more thereof and the ethylene copolymer includes ethylene/alkyl (meth)acrylate copolymer, ethylene/alkyl acrylate/glycidyl (meth)acrylate copolymer, ethylene/(meth)acrylic acid copolymer, ionomer of the ethylene/(meth)acrylic acid copolymer, or combinations of two or more thereof.

2. The multilayer structure of claim 1 wherein the sulfonic acid comonomer is the salt of the acid and the composition includes polyethylene terephthalate 5-sodium sulfoisophthalate terpolymer, a blend of polyethylene terephthalate 5-sodium sulfoisophthalate terpolymer and polyetherester elastomer block copolymer, a blend of polyethylene terephthalate 5-sodium sulfoisophthalate terpolymer and polyethylene terephthalate, a blend of polyethylene terephthalate 5-sodium sulfoisophthalate terpolymer and ethylene/acrylic acid copolymer and ethylene/methyl acrylate copolymer, a blend of polyethylene terephthalate 5-sodium sulfoisophthalate terpolymer and ethylene/acrylic acid copolymer and ethylene/n-butyl acrylate copolymer, a blend of polyethylene terephthalate 5-sodium sulfoisophthalate terpolymer and ethylene/n-butyl acrylate glycidyl methacrylate terpolymer, or combinations of two or more thereof.

3. The multilayer structure of claim 2 wherein the salt includes calcium salt, zinc salt, lithium salt, sodium salt, or combinations of two or more thereof.

4. The multilayer structure of claim 1 wherein the polyester composition is a blend of bulk polyester and a copolymer of polyester and from about 0.005 to about 7 mole % of the sulfonic acid comonomer.

5. The multilayer structure of claim 3 wherein the polyester composition is a blend of bulk polyester and a copolymer of polyester and from about 0.025 to about 2.5 mole % of the sulfonic acid comonomer.

6. The multilayer structure of claim 5 wherein the blend ratio of a bulk polymer to copolymer of polyester and sulfonic acid comonomer is about 0.1: 99.9 to about 99.9:0.1 or about 75:25 to about 99.9:0.1.

7. The multilayer structure of claim 4 wherein the bulk polymer is a polyethylene terephthalate homopolymer, polyethylene terephthalate copolymer, polybutylene terephthalate homopolymer, polyester elastomer, polyetherester block copolymer, or combinations of two or more thereof having a melt temperature in a range from about 150° C. to about 300° C. or about 195° C. to about 258° C. and an inherent viscosity from about 0.58 to about 1.1; and the polyetherester block copolymer comprises a crystalline segment of polybutylene terephthalate and amorphous segments based on long-chain polyether glycols.

8. The multilayer structure of claim 5 wherein the bulk polymer is a polyethylene terephthalate homopolymer, polyethylene terephthalate copolymer, polybutylene terephthalate homopolymer, polyester elastomer, polyetherester block copolymer, or combinations of two or more thereof having a melt temperature in a range from about 230° C. to about 258° C. and an inherent viscosity from about 0.67 to about 1.1 or about 0.72 to about 0.9; and the polyetherester block copolymer comprises a crystalline segment of polybutylene terephthalate and amorphous segments based on long-chain polyether glycols.

9. The multilayer structure of claim 8 wherein the bulk polymer is the polyethylene terephthalate homopolymer or polyethylene terephthalate copolymer.

10. The multilayer structure of claim 7 wherein the bulk polymer is a polyester elastomer.

11. The multilayer structure of claim 8 wherein the bulk polymer is the polyetherester block copolymer.

12. The multilayer structure of claim 1 wherein the polyester composition is a random copolyester or a block copolyester.

13. The multilayer structure of claim 7 wherein the polyester composition is a random copolyester or a block copolyester.

14. The multilayer structure of claim 8 wherein the polyester composition is a random copolyester or a block copolyester.

15. The multilayer structure of claim 1 further comprising a second layer and optionally a third layer wherein the second layer comprises polyamide, a second polyester, or both, and the third layer includes a second polyester, polycarbonate, or both.

16. The multilayer structure of claim 4 further comprising a second layer and optionally a third layer wherein the second layer comprises polyamide, a second polyester, or both, and the third layer includes a second polyester, polycarbonate, or both.

17. The multilayer structure of claim 6 further comprising a second layer and a third layer wherein the second layer comprises polyamide, a second polyester, or both, and the third layer includes a second polyester, polycarbonate, or both.

18. The multilayer structure of claim 7 further comprising a second layer and a third layer wherein the second layer comprises polyamide, polyethylene terephthalate, or both, and the third layer includes polyethylene terephthalate, polycarbonate, or both.

19. The multilayer structure of claim 8 further comprising a second layer and a third layer wherein the second layer comprises polyamide, polyethylene terephthalate, or both, and the third layer includes polyethylene terephthalate, polycarbonate, or both.

20. The multilayer structure of claim 19 wherein the bulk polymer is the polyethylene terephthalate homopolymer or polyethylene terephthalate copolymer.

21. The multilayer structure of claim 19 wherein the bulk polymer is a polyester elastomer.

22. The multilayer structure of claim 19 wherein the bulk polymer is the polyetherester block copolymer.

23. A composition comprising a blend of a first polyester and polyetherester elastomer block copolymer, a blend of a polyester and polyethylene terephthalate, a blend of a polyester and one or more ethylene copolymers, or combinations of two or more thereof wherein
the first polyester is a polyethylene terephthalate 5-sodium sulfoisophthalate comprises from about 0.001 to about 7 mole %, or about 0.005 to about 7 mole %, of a sulfonic acid comonomer or a blend of bulk polyester and the polyethylene terephthalate 5-sodium sulfoisophthalate in which the blend ratio of bulk polymer to copolymer of polyester and sulfonic acid comonomer is about 0.1: 99.9 to about 99.9:0.1 or about 75:25 to about 99.9:0.1;
the bulk polyester is a polyethylene terephthalate homopolymer, polyethylene terephthalate copolymer, polybutylene terephthalate homopolymer, polyester elastomer, polyetherester block copolymer, or combinations of two or more thereof each having a melt temperature in a range from about 150° C. to about 300° C. or about 195° C. to about 258° C. and an inherent viscosity from about 0.58 to about 1.1 and the polyetherester block copolymer comprises a crystalline segment of polybutylene terephthalate and amorphous segments based on long-chain polyether glycols;
the ethylene copolymer includes ethylene/alkyl (meth)acrylate copolymer, ethylene/alkyl acrylate/glycidyl (meth)acrylate copolymer, ethylene/(meth)acrylic acid copolymer, ionomer of the ethylene/(meth)acrylic acid copolymer, or combinations of two or more thereof; and
the sulfonic acid includes sulfobenzenedicarboxylic acid, a salt of the acid, an ester of the acid, an ester of the salt, or combinations of two or more thereof.

24. The composition of claim 23 wherein the sulfonic acid comonomer is the salt of the acid including calcium salt, zinc salt, lithium salt, sodium salt, or combinations of two or more thereof.

25. The composition of claim 24 wherein the bulk polymer is the polyethylene terephthalate homopolymer, polyethylene terephthalate copolymer, a polyester elastomer, polyetherester block copolymer, or combinations of two or more thereof.

26. The multilayer structure of claim 25 wherein the polyester composition is a random copolyester or a block copolyester.

27. A process comprising contacting a first polyester with a second polyester under a solid state polymerization condition wherein the first polyester is the same as recited in claim 23 and the second polyester is a thermoplastic polyetherester elastomer, polyether elastomer, or combinations thereof.

28. The process of claim 27 wherein the first polyester and second polyester are each present in the range of from about 25-75 wt % based on the total weight of the first polyester and second polyester and the condition includes a temperature about 10° C. to about 60° C. below the melting point of the lower melting point of the first polyester or the second polyester.

29. The multilayer structure of claim 4 being converted to an article including solid extruded profile, tubing, an over-molded part, or combinations of two or more thereof.
